(19) United States
(12) Patent Application Publication
(10) Pub. No.: US 2023/0368069 A1
(43) Pub. Date: Nov. 16, 2023

(54) MACHINE LEARNING FEATURE HEALTH MONITORING AND ANOMALY DETECTION

(71) Applicant: Microsoft Technology Licensing, LLC, Redmond, WA (US)

(72) Inventors: Zhentao Xu, Sunnyvale, CA (US); Ruoying Wang, Los Altos, CA (US); Xinwei Gong, Mountain View, CA (US); Ian R. Ackerman, San Francisco, CA (US); Tie Wang, San Jose, CA (US); Amol N. Ghoting, San Ramon, CA (US)

(21) Appl. No.: 17/745,336

(22) Filed: May 16, 2022

(51) Int. Cl. G06N 20/00; G06F 11/34

(52) U.S. Cl. CPC G06N 20/00; G06F 11/3495

(57) ABSTRACT

Technologies for monitoring input feature health for machine learning models and detecting anomalies are described. Embodiments include receiving, by a trained machine learning model and from an online system, a set of historical values and a current feature value of a time series feature, the time series feature represents one or more measured values of the online system. Embodiments include predicting an expected feature value and an expected range of values using the set of historical values. Embodiments include receiving the expected feature value and the expected range of values. Embodiments include receiving the current feature value. Embodiments include determining that an anomaly condition is present based on the current feature value, the expected feature value, and the expected range of values. Embodiments include generating an alert for the anomaly condition that includes the severity metric and the duration metric.

### TECHNICAL FIELD

The present disclosure generally relates to determining the health of features used by machine learning models, and more specifically, relates to feature health monitoring and anomaly detection within the features used by machine learning models.

### BACKGROUND

Online platforms, such as digital marketplaces, receive and distribute massive amounts of information. Many online platforms use machine learning models to perform various analytics processes. Through training processes, machine learning models learn relationships among different types of information. Once trained, machine learning models generate predictive data, such as scores or probabilities. Whether in a training mode or a prediction mode, machine learning models ingest and may generate data known as features.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a computing system that includes an adaptive feature health monitoring system in accordance with some embodiments of the present disclosure.

FIG. 2 is an example of a process to monitor input feature health in accordance with some embodiments of the present disclosure.

FIG. 3 is an example of a process for anomaly detection and alert generation in accordance with some embodiments of the present disclosure.

FIG. 4 is a flow diagram of an example architecture of an adaptive feature health monitoring system in accordance with some embodiments of the present disclosure.

FIG. 5 is an example of a process for input feature health monitoring and anomaly detection in accordance with some embodiments of the present disclosure.

FIG. 6 is an example of experimental results that may be obtained with some embodiments of the present disclosure.

FIG. 7 is a block diagram of an example computer system for implementing an adaptive feature health monitoring system in accordance with some aspects of the present disclosure.

### DETAILED DESCRIPTION

Health monitoring for features used by machine learning models of large online and offline systems presents challenges of identifying anomalies and generating accurate alerts because of the wide variation in scale of feature values, seasonality of certain features, and variable boundary conditions. A feature represents a measurable variable of the online or offline system and is used by the machine learning models for performing analysis. Each feature has a range of values that occur with a distribution over time. Feature health represents a reliability of the feature for use by machine learning models. A feature that becomes overly noisy or has large deviations from the typical range indicates that the feature may be unhealthy. Without monitoring the features, a machine learning model would use these noisy or deviant values resulting in a negative impact to the performance of the machine learning model. By applying monitoring to the feature health, a feature that is deviating or noisy can be identified and an alert that model performance is less reliable can be generated. In response to the alert, the feature can be removed from use by the machine learning model or investigated to determine the cause of the change in health. Feature healthiness can be adversely affected by, for example, large feature sizes, complicated feature generation pipelines, or a mixture of different feature sources. Feature healthiness impacts both the model offline training and online inference scenarios.

Examples of features that can be monitored include input features of machine learning models. Input features as used herein refer to individual values of independent variables that are input to the machine learning model. Examples of input features include user clicks, message counts, content posts, document counts, activities by a user interacting with an online system, or any combination of the foregoing. Input features are not limited to user interaction data. Alternatively or in addition, input features include measurements and/or characteristics of physical attributes of electronic devices of the computer system, such as sensor data and performance metrics like throughput, processing time, latency, and storage capacity.

An example of a boundary is a line or curve which distinguishes an anomaly condition from a nominal condition. A boundary condition is, for instance, a set of conditions that are used to determine whether a current feature's value is a true anomaly based on its position relative to the boundary such as a position on one side of the curve that separates anomaly conditions from normal conditions.

It has been a challenge to accommodate close cross-boundary cases that are not truly anomaly conditions requiring alerts. As online systems continue to grow, an adaptive feature health monitoring system that addresses these and other challenges is needed. For instance, in a close cross-boundary case, the current feature's value may be positioned on the side of the curve that represents an anomaly condition but be located within a threshold distance of the curve. In these cases, the current feature's value might be a true anomaly, but could also be a false positive because the position of the curve is fixed and unable to account for small range deviations.

Existing feature health monitoring systems that are built on a statistical model have suffered from a high false alert rate. Due to simple model architectures, spline-based time-series prediction models, which use unsupervised detection method and lack any anomaly filtering mechanism, tend to send false alerts.

Additionally, existing models require users to tune multiple hyperparameters for each feature based on an individual seasonality pattern and noisiness of each feature. This requirement to manually perform tuning further increases the difficulty of using these existing models. The manual tuning and false alerts combine to reduce performance and often cause existing models to fail to satisfy a mean time to detect (MTTD) requirement.

Another existing approach has attempted to use deep learning models to predict changes in feature health. This approach has used a sign test to generate alerts. Using the sign test, if the difference between a predicted baseline value and an observed value exceeds a predefined threshold, the deep learning model signals that an anomaly condition exists. However, in this approach, the threshold is rigidly applied once it is defined. As a result, the approach is unable to adapt to feature values that validly change over time, such as feature values that have a seasonality component. This lack of adaptability can cause existing systems to miss anomalies, especially in close cross-boundary cases. When feature anomalies go undetected, the quality and reliability of the machine learning model output declines. When the quality and reliability of machine learning model output declines, downstream systems that use the machine learning model output can make consequential errors such as executing the wrong logic.

Moreover, a widespread problem with existing deep learning feature health monitoring approaches is that existing systems treat a prediction boundary in a “Boolean” way, meaning that all out-of-boundary points are treated equally, no matter how far the points are away from the boundary, resulting in a much higher-than-expected false alert rate. For example, existing systems problematically treat many data points as abnormal even though they are only slightly beyond the boundaries.

One solution for the prediction boundary problem of false alerts is simply to increase the boundary dispersion, which increases the distance between an upper boundary and a lower boundary, by updating the quantile in the machine learning model's quantile loss. A quantile loss is a metric that is used by the time series predictor to minimize the error when predicting expected values that fall within a certain quantile. An example of a quantile is a median (e.g., a 50th percentile). For a median, the quantile loss is a summation of absolute error from a true value. Quantile loss can be used by the time series predictor to predict expected ranges that can be defined by a top and bottom percentile or a top and bottom value. Updating the quantile reduces the alert rate slightly. However, some types of features, for example, features that do not have a regular seasonality pattern, lie outside of boundaries and trigger noisy alerts. Additionally, merely increasing the boundary dispersion can easily lead to missing true anomalies, especially for seasonality-based anomalies.

Aspects of the present disclosure address the above and other deficiencies by providing an adaptive feature health monitoring system that includes two stages: (1) a deep learning-based time series predictor and (2) an adaptive anomaly detector. The deep learning-based time series predictor is a trained deep learning model, and the adaptive anomaly detector is a trained classifier.

Aspects of the present disclosure apply supervised anomaly detection that monitors input features for potential anomalies, and, if a potential anomaly is detected, validates the anomaly by evaluating the severity and duration of the anomaly. Aspects of the present disclosure include training an anomaly detector to filter a feature anomaly using the time series predictor's predicted expected value and boundary conditions. The anomaly detector determines a distance between a measured feature value and a boundary condition to determine whether the measured feature value is an anomaly. The anomaly detector is a classifier trained with annotated anomaly data using supervised learning to learn to distinguish between actual anomalies and false alerts. The anomaly detector can reduce the false alert rate for close-boundary outliers, which are usually false alerts based on historical analysis.

Additionally, the combination of the time series predictor and the anomaly detector have produced a very low number of false alerts (e.g., less than 0.1 false alerts per month) during experimental testing. Aspects of the present disclosure provide generalizability to apply to any machine learning model without any human-involved hyper-parameter tuning, while still achieving consistently high performance. Embodiments that include the combination of both the time series predictor and the anomaly detector provide robust prediction and filtering. As a result, the MTTD can be reduced from weeks (or longer if users turn off the alert due to noisiness) to a matter of days (for daily aggregated metrics) or even shorter (for metrics with more frequent cadence).

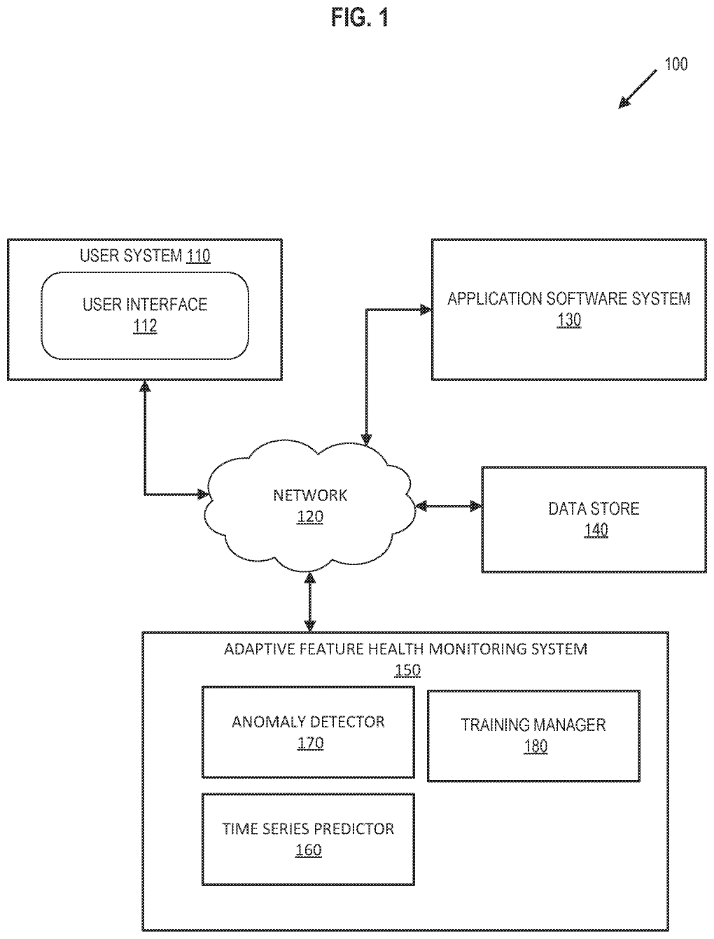

FIG. 1 illustrates an example of a computing system 100 that includes an adaptive feature health monitoring system 150 in accordance with some embodiments of the present disclosure. Computing system 100 includes a user system 110, a network 120, an application software system 130, a data store 140, and an adaptive feature health monitoring system 150. Adaptive feature health monitoring system 150 includes an anomaly detector 170, a time series predictor 160, and a training manager 180.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 includes a front-end portion of application software system 130.

User interface 112 is any type of user interface as described above. User interface 112 is used to input feature values and view or otherwise perceive output that includes data produced by application software system 130. For example, user interface 112 includes a graphical user interface and/or a conversational voice/speech interface that includes a mechanism for entering a feature value and viewing anomaly detection results and/or other digital content. Examples of user interface 112 include web browsers, command line interfaces, and mobile apps. User interface 112 as used herein includes application programming interfaces (APIs). In some embodiments, the user interface 112 is configured to receive input from a user and present data to the user. The user interface 112 receives inputs, such as from a user input device (not shown). For example, the user interface 112 presents data to the user requesting input, such as an anomaly detection of a particular feature. The user interface 112 presents various media elements to the user including audio, video, image, haptic, or other media data.

Data store 140 is a memory storage. Data store 140 stores feature data, such as time series data created from an online system, including time stamp information, user interaction data, system identification data, as well as machine learning model outputs. Data store 140 resides on at least one persistent and/or volatile storage device that resides within the same local network as at least one other device of computing system 100 and/or in a network that is remote relative to at least one other device of computing system 100. Thus, although depicted as being included in computing system 100, portions of data store 140 could be part of computing system 100 or accessed by computing system 100 over a network, such as network 120. For example, data store 140 could be part of a data storage system that includes multiple different types of data storage and/or a distributed data service. As used herein, data service could refer to a physical, geographic grouping of machines, a logical grouping of machines, or a single machine. For example, a data service could be a data center, a cluster, a group of clusters, or a machine.

Application software system 130 is any type of application software system that includes or utilizes functionality provided by adaptive feature health monitoring system 150. Examples of application software system 130 include but are not limited to connections network software, such as social media platforms, and systems that are or are not based on connections network software, such as general-purpose search engines, job search software, recruiter search software, sales assistance software, content distribution software, learning and education software, or any combination of any of the foregoing. Other examples of application software system 130 include but are not limited to digital commerce software, such as social media storefronts, and systems that are or are not based on digital commerce software, such as general-purpose software distribution platform, software repository, or software-as-a-service providers, or any combination of any of the foregoing.

While not specifically shown, it should be understood that any of user system 110, application software system 130, data store 140, adaptive feature health monitoring system 150, anomaly detector 170, and time series predictor 160 includes an interface embodied as computer programming code stored in computer memory that when executed causes a computing device to enable bidirectional communication with any other of user system 110, application software system 130, data store 140, adaptive feature health monitoring system 150, anomaly detector 170, and time series predictor 160 using a communicative coupling mechanism. Examples of communicative coupling mechanisms include network interfaces, inter-process communication (IPC) interfaces and application program interfaces (APIs).

A client portion of application software system 130 operates in user system 110, for example as a plugin or widget in a graphical user interface of a software application or as a web browser executing user interface 112. In an embodiment, a web browser transmits an HTTP request over a network (e.g., the Internet) in response to user input that is received through a user interface provided by the web application and displayed through the web browser. A server running application software system 130 and/or a server portion of application software system 130 receives the input, performs at least one operation using the input, and returns output using an HTTP response that the web browser receives and processes.

Each of user system 110, application software system 130, data store 140, adaptive feature health monitoring system 150, anomaly detector 170, and time series predictor 160 is implemented using at least one computing device that is communicatively coupled to electronic communications network 120. Any of user system 110, application software system 130, data store 140, adaptive feature health monitoring system 150, anomaly detector 170, and time series predictor 160 is bidirectionally communicatively coupled by network 120. User system 110 as well as one or more different user systems (not shown) could be bidirectionally communicatively coupled to application software system 130.

A typical user of user system 110 could be an administrator or end user of application software system 130, adaptive feature health monitoring system 150, anomaly detector 170, and/or time series predictor 160. User system 110 is configured to communicate bidirectionally with any of application software system 130, data store 140, adaptive feature health monitoring system 150, anomaly detector 170, and/or time series predictor 160 over network 120.

The features and functionality of user system 110, application software system 130, data store 140, adaptive feature health monitoring system 150, anomaly detector 170, and/or time series predictor 160 are implemented using computer software, hardware, or software and hardware, and includes combinations of automated functionality, data structures, and digital data, which are represented schematically in the figures. User system 110, application software system 130, data store 140, adaptive feature health monitoring system 150, anomaly detector 170, and time series predictor 160 are shown as separate elements in FIG. 1 for ease of discussion but the illustration is not meant to imply that separation of these elements is required. The illustrated systems, services, and data stores (or their functionality) could be divided over any number of physical systems, including a single physical computer system, and could communicate with each other in any appropriate manner.

Network 120 could be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

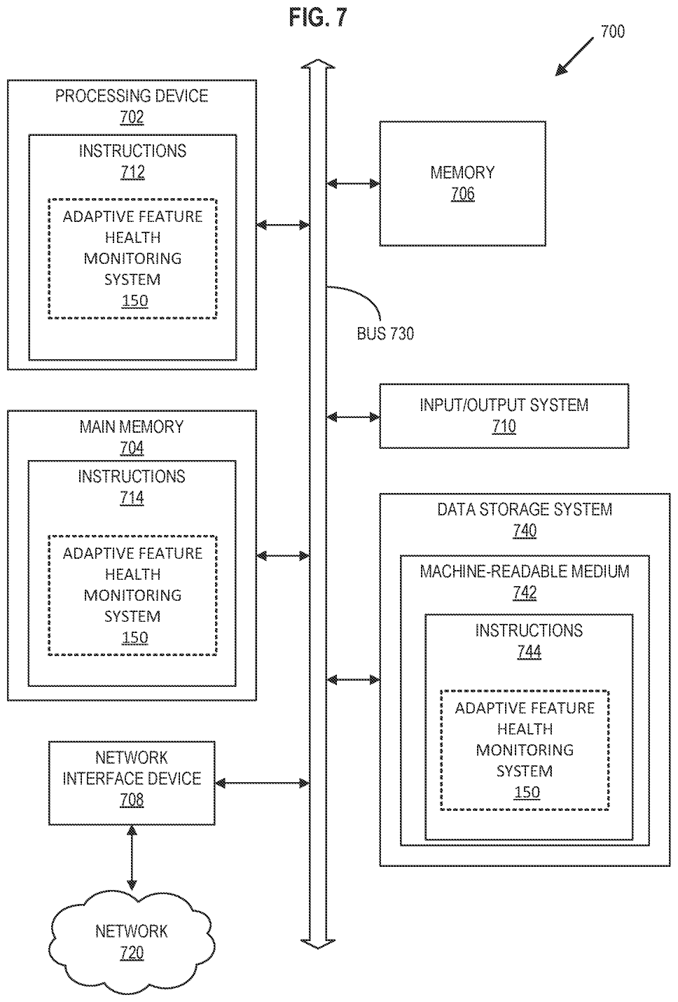

The computing system 100 includes an adaptive feature health monitoring system 150 that applies an anomaly detector 170 and a time series predictor 160 to a feature of computing system 100 that can be stored in data store 140. The adaptive feature health monitoring system 150 uses the time series predictor 160 to predict an expected value of the feature and a range of expected values. The anomaly detector 170 determines, using a current feature value of the feature, the expected value, and the range of expected values, whether the current feature value of the feature is an anomaly. In some embodiments, the application software system 130 includes at least a portion of the anomaly detector 170 and/or time series predictor 160. As shown in FIG. 7, the adaptive feature health monitoring system 150 could be implemented as instructions stored in a memory, and a processing device 702 could be configured to execute the instructions stored in the memory to perform the operations described herein.

The adaptive feature health monitoring system 150 provides adaptive feature health monitoring and anomaly detection for an online platform. While adaptive feature health monitoring system 150 is described as an executable application, in some embodiments, the adaptive feature health monitoring system 150 could be implemented in specialized hardware or as a cloud Software or as a Service (SaaS) application. The disclosed technologies are described with reference to an example use case of monitoring feature health of an online platform. The disclosed technologies are not limited to online platforms but could be used to detect anomaly conditions for features used in machine learning models more generally. The disclosed technologies could be used by many different types of network-based applications for feature anomaly detection. The adaptive feature health monitoring system 150 could perform the described functions in an offline (periodic feature health monitoring) or in an online (real-time or near real-time feature health monitoring) mode. The features include the examples above or temporal sequences of any of the foregoing (e.g., time series data), such as running counts.

The adaptive feature health monitoring system 150 of FIG. 1 includes the anomaly detector 170 and the time series predictor 160. Some embodiments of the anomaly detector include one or more classifiers for determining an anomaly condition of a feature from an expected value of a feature, an expected range of the feature, and a current feature value of the feature. In some embodiments, one or more features of the online platform are obtained by the adaptive feature health monitoring system 150. In some embodiments, the adaptive feature health monitoring system 150 requests the one or more features from the application software system 130. For example, the adaptive feature health monitoring system 150 monitors various functions of the online platform and designates a set of features associated with each function for anomaly detection. The adaptive feature health monitoring system 150 applies filtering to the set of features to determine a critical set of features that provide additional analytics information relating to the various functions of the online platform. In this example, the adaptive feature health monitoring system 150 can filter features that are constant or are overly noisy so that they are not included in the critical set of features.

The time series predictor 160 predicts an expected value and an expected range of values for each feature of the online system. For example, the time series predictor 160 is a multilayer perceptron model that receives aggregated features from the online platform. In some embodiments, the time series predictor 160 receives features that are aggregated on a daily time interval to regulate input size, but other time intervals could be used. The time series predictor 160 includes a seasonality adaptive layer that encodes feature cycles as features for predicting the expected values. In some examples, the seasonality includes but is not limited to 1-day, 1-week, hours of day, day of week, month to month, or other time intervals.

In some embodiments, the adaptive feature health monitoring system 150 applies a normalization process to the feature values prior to ingestion by the time series predictor 160. The normalization is a datapoint-wise normalization that projects historical values into a normalized space before being provided to the time series predictor 160. After the time series predictor 160 predicts the expected values and range of expected values, the adaptive feature health monitoring system 150 applies an inverse normalization. By applying the datapoint-wise normalization, information leakage is reduced because each historical feature value will be equally standardized which decreases the influence of other feature values and maps the feature space of the time series predictor to a common scale.

The time series predictor 160 is configured to discard a set of feature values within a threshold time interval. The time series predictor 160 discards feature values from the set of feature values that are the most recent values in the set of feature values such as a number of days, weeks, or months, depending on the total time interval of the set of feature values. In one example, the set of feature values includes 28 days of aggregated feature values. For this example, the time series predictor 160 discards feature values within three days of the current feature value. The time series predictor 160 discards these feature values to prevent over reliance of the time series predictor on a small subset of most recent feature values. A representation of removing the feature values within a threshold time is defined by an equation, shown below, with H representing a time series of the feature, t is a timestamp for which a prediction is being made, h represents a minimal historical time (i.e., days) for computing the prediction, and k represents the threshold time with all feature values within the threshold time of the timestamp for which a prediction is being made are removed.

$$y ( t ) = model ( H [ t - h : t - 1 ] ) \to y ( t ) = model ( T [ t - h : t - 1 - k ] )$$

The time series predictor 160 provides the expected value and the range of expected values (an upper boundary value and a lower boundary value forming a range) to the anomaly detector 170 to determine whether an anomaly condition is present in the feature. The anomaly detector 170 filters all of the output of the time series predictor to distinguish a true anomaly condition based on the expected value, upper boundary, and lower boundary of the expected range of values. Using the upper boundary and lower boundary, the anomaly detector 170 accounts for a distance from one of the boundaries to the current feature value. The anomaly detector 170 is trained by supervised learning using annotated anomaly data that includes at least some training data where a current feature value is outside the training range and yet does not represent an anomaly condition. In some embodiments, the annotated anomaly data is generated using validated true anomaly conditions such as by a user annotation of training data. This provides the anomaly detector 170 with the capability to reduce false anomaly detection for close boundary values where the current feature value exceeds the expected range but is within a threshold proximity to the upper boundary or lower boundary.

As illustrated in FIG. 1 the adaptive feature health monitoring system 150 also includes training manager 180. The training manager 180 can teach, guide, tune, and/or train one or more neural networks, such as time series predictor 160 or anomaly detector 170. In particular, the training manager 180 can train a neural network based on a plurality of training data.

In an example, the training manager 180 receives annotated training data for a feature that includes a training feature value, a training expected value, a training expected range, and an anomaly condition indicator. In this example, the training feature value is a number of search queries on the online platform. The training expected value is 10, and the training expected range is defined by an upper boundary of 20 and a lower boundary of 5. The training feature value is 22 and the anomaly condition indicator is false (i.e., not an anomaly condition). In this example, the training feature value of 22 is a close cross-boundary case (22 relative to the upper bound of 20) and the annotation indicates that this training feature value is not an anomaly condition.

In another example, the training feature value is a number of user authentications on the online platform. The training expected value is 15, and the training expected range is defined by an upper boundary of 18 and a lower boundary of 13. The training feature value is 20 and the anomaly condition indicator is true (i.e., a true anomaly condition). In this example, the training expected range is narrower (5 units) than the previous example. This example represents a feature that has a narrow expected range of values. Thus, even though the absolute difference in the training feature value and the upper boundary is the same as the previous example, a true anomaly exists because of the narrower expected range.

In another example, the training feature value is an operating state of a computing device of the computing system. The training expected value is that the computing device is operating at 75% of a physical performance limit, and the training expected range is defined by an upper boundary of 85% and a lower boundary of 50%. The training feature value is 92% and the anomaly condition indicator is true (i.e., a true anomaly condition).

As described in the above examples, the time series predictor 160 is trained to generate expected values and expected ranges of values including an upper boundary and lower boundary. Additionally, the time series predictor 160 may be further optimized using loss functions. The anomaly detector 170 is trained to detect anomaly conditions using the expected values and expected ranges of values including an upper boundary and lower boundary and the annotated anomaly condition for feature in the training data. More specifically, the training manager 180 can access, identify, generate, create, and/or determine training input and utilize the training input to train and fine-tune a neural network.

The time series predictor 160 is configured to include a seasonality adaptive layer and the training manager 180 trains the time series predictor 160 including a training seasonality value in the set of training time series feature values. The training manager 180 trains the time series predictor 160 using the set of training time series feature values and the set of training anomaly labels to detect an anomaly condition using the expected feature value and an expected range of feature values generated by the time series predictor 160. In some embodiments, the set of training time series feature values includes a training feature value and a training range of feature values. The set of training anomaly labels includes an identification of an anomaly condition and a type associated with the anomaly condition. Examples of the type associated with the anomaly condition include a severity, duration, cumulative severity, or concurrency anomaly. The training manager 180 performs a normalization operation on the set of training time series feature values prior to training the machine learning model.

Further details regarding an example architecture of the adaptive feature health monitoring system, time series predictor, and anomaly detector are described below.

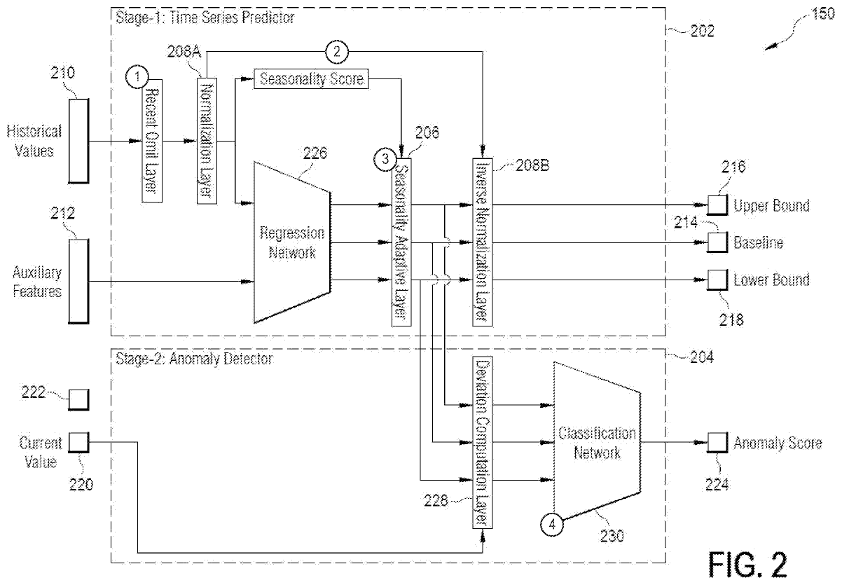

FIG. 2 is an example architecture of an adaptive feature health monitoring system in accordance with some embodiments of the present disclosure. The adaptive feature health monitoring system 150 includes two stages: (1) a time series predictor 202 and (2) an anomaly detector 204 that are used to determine anomaly conditions. As illustrated in FIG. 2, stage 1 includes the time series predictor 202 and stage 2 includes the anomaly detector 204, with each stage including a different trained machine learning model.

Time series predictor 202 is one example embodiment of time series predictor 160 and anomaly detector 204 is one example embodiment of anomaly detector 170. The time series predictor 160 receives a set of historical feature values 210 and a set of auxiliary feature values 212. The set of historical feature values 210 is a set of previous values of the feature being analyzed for a potential anomaly. The set of auxiliary features 212 includes values that represent a day of the week (e.g., Monday), or a month (e.g., July). In some embodiments, the set of auxiliary features 212 can also include but is not limited to a seasonality factor, for one or more of the historical feature values. The seasonality factor indicates a cyclical characteristic of the feature such as an encoding of a weekly, monthly, or other time interval for which the feature has as cyclical period. More or less features can be included in the set of auxiliary features 212 according to specific configurations of the adaptive feature health monitoring system 150.

The time series predictor 160 predicts, using the set of historical feature values 210 and the set of auxiliary feature values 212, an expected value 214, an upper boundary 216, and a lower boundary 218, which can include a range computed by the difference between the upper boundary 216 and the lower boundary 218. The time series predictor 160 is configured to receive feature values from the online platform. The feature values include a set of historical feature values 210 and a set of auxiliary feature values 212. The set of historical feature values 210 include multiple feature values within a predetermined time window such as one week, one month or one year. At numeral 1, the time series predictor 160 is configured to exclude a set of feature values within a threshold time of the current time from the set of historical feature values. The threshold time is configurable for a specific set of historical feature values, but in one example, the threshold time is three days. The time series predictor 202 discards values from the set of historical feature values that are within the threshold time which prevent the regression network 226 from short-cutting the prediction by returning a most recent previous value to achieve small mean-squared error loss. The discarding of the values from the set of historical feature values improves the machine learning model and makes it more robust against recent anomalies and thus has fewer missing anomalies and higher recall over a longer period.

At numeral 2, the time series predictor 202 includes a normalization layer 208A that projects the set of historical feature values 210 into a normalized space. The time series predictor 202 applies a regression network 226 to the normalized space representing the set of historical feature values 210.

At numeral 3, the time series predictor 160 applies a seasonality adaption layer 206 that encodes feature cycles (e.g., repeat values or repeating patterns such as a weekly trend from high to low) as features for inferring patterns of each feature within the normalized space. The time series predictor 202 communicates the outputs of the seasonality adaptive layer to the anomaly detector 204. The time series predictor 202 applies an inverse normalization layer 208B to outputs of the regression network 226 after processing by the seasonality adaption layer 206. The time series predictor 202 outputs the expected value 214, upper boundary 216, and the lower boundary 218 after the inverse normalization layer 208B. The seasonality adaptive layer 206 can use the seasonality factor associated with a particular feature to infer seasonality of a particular feature beyond any patterns in just the historical feature values 210. The seasonality adaptive layer 206 computes a boundary condition for the expected range of values for the set of historical values. The seasonality pattern of the set of historical values is used to derive a threshold regularity (e.g., a regularity over a time interval) of a range of the set of historical values compared to a different set of historical values. For instance, given a boundary condition for the set of historical values, the seasonality adaptive layer can adjust the expected range using a quantile regression to accommodate close boundary cases.

By normalizing the set of historical feature values 210, each historical feature value will be standardized which allows the feature space of the machine learning model to be mapped to a common scale across all of the set of historical feature values 210. The adaptive feature health monitoring system 150 is further configured to perform an inverse normalization after the seasonally adaptive layer and before outputting the expected feature value and a range of expected values including an upper boundary 216 and a lower boundary 218.

The time series predictor 160 predicts an expected feature value and a range of expected values including an upper boundary 216 and a lower boundary 218 using the set of historical feature values 210 and the set of auxiliary feature values 212. The time series predictor 160 provides the expected feature value and the range of expected values to the anomaly detector 204 for determination of whether an anomaly condition is present.

The anomaly detector 204 can receive the current feature value 220 and a set of predicted values 222 that includes the upper boundary 216, the expected value 214, and the lower boundary 218. The anomaly detector 204 generates an anomaly score 224 that indicates a probability of the current feature value 220 being an anomaly condition. The anomaly detector 204 outputs a potential anomaly condition when the anomaly score 224 is above a threshold (e.g., 0.50). The anomaly detector 204 outputs the potential anomaly to the adaptive feature health monitoring system 150 for generating an alert or additional processing such as applying filtering.

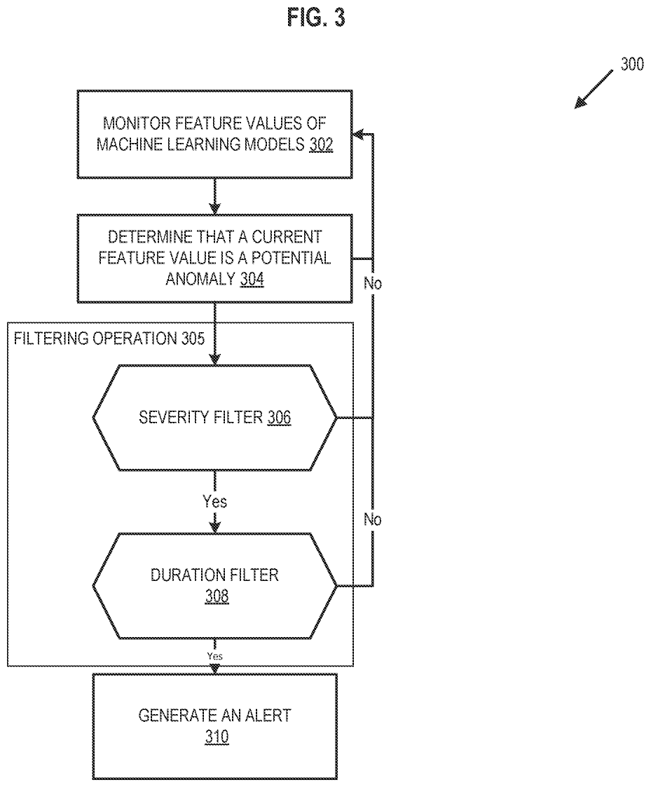

At numeral 4, the anomaly detector 204 includes a classification network 230. The classification network determines that an anomaly condition is present based on the current feature value, the expected feature value, and the expected range of values. The anomaly detector 204 predicts an anomaly condition by comparing an upper boundary of the expected range and a lower boundary of the expected range to the current feature value. The anomaly detector 204 also uses a distance between the current feature value and the closest boundary of the expected range to distinguish between a false alert and a true anomaly condition in close boundary conditions. The anomaly detector 204 is trained using a supervised training process. The anomaly detector is a classifier trained with annotated anomaly data using supervised learning to learn to distinguish between actual anomalies and false alerts. The anomaly detector can reduce the false alert rate for close-boundary outliers, which are usually false alerts based on historical analysis. In some embodiments, the anomaly detector 204 is configured to perform filtering operations as described below with regard to FIG. 3.

FIG. 3 is a flow diagram of an example method 300 of generating alerts for potential anomalies in accordance with some embodiments of the present disclosure.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by portions of the adaptive feature health monitoring system 150 of FIG. 1.

Although shown in a particular sequence or order, unless otherwise specified, the order of the processes could be modified. Thus, the illustrated embodiments should be understood only as examples, and the illustrated processes could be performed in a different order, and some processes could be performed in parallel. Additionally, one or more processes could be omitted in various embodiments. Thus, not all processes are required in every embodiment. Other process flows are possible.

At operation 302, the adaptive feature health monitoring system monitors feature values of machine learning models. The adaptive feature health monitoring system receives the feature values from the online platform at various time intervals. For example, the machine learning model receives multiple time series features from the online system. For each time series feature, the time series predictor receives a set of historical values and the current feature value.

In some embodiments, the adaptive feature health monitoring system monitors the health of machine learning model features that represent physical attributes of a computing device or other type of electronic device. For example, a physical attribute can be total operating time, down-time, an error code, or an operating status. These features related to physical attributes of a device are received as time series feature values.

At operation 304, the adaptive feature health monitoring system determines that a current feature value of a feature is a potential anomaly. To make this determination, the adaptive feature health monitoring system analyzes the feature values by applying a time series predictor to predict an expected value of the feature and an upper boundary value and a lower boundary value. The adaptive feature health monitoring system also applies an anomaly detector to determine whether the current feature value of the feature is a potential anomaly. If the anomaly detector determines that the current feature value is a potential anomaly, the flow proceeds to filtering operation 305. If the anomaly detector determines that the current feature value is not a potential anomaly, the flow proceeds to go back to operation 302.

At filtering operation 305, the adaptive feature health monitoring system analyzes each potential anomaly condition and applies one or more filters to reduce the number of alerts from the total potential anomaly conditions to only the anomaly conditions which satisfy each of the filters of the filtering operation. While filtering operation 305 includes a duration filter and a severity filter as depicted in FIG. 3, additional or fewer filters can be applied within filtering operation 305. The filtering operation 305 applies a time window to the potential anomaly and is given a set of feature-level anomalies filters to filter out false alerts to generate a subset of verified anomalies that satisfy conditions for notification of one or more users of the adaptive feature health monitoring system. The filtering operation can operate in two modes including (1) an aggressive mode and (2) a conservative mode. When the filtering operation is in the aggressive mode, the filter applies “OR” logic and generates an alert generated if any filter (i.e., operation 308 OR operation 308) detects an anomaly. When the filtering operation is in the conservative mode, the filter applies “AND” logic and generates an alert only when all filters (i.e., operation 308 AND operation 308) detect an anomaly. While the filtering operation 305 depicts operation 306 and operation 308 in a sequential manner, a parallel execution can be implemented with both operation 306 and operation 308 occurring simultaneously.

At operation 306, the adaptive feature health monitoring system applies a severity filter to determine whether the potential anomaly condition satisfies a severity threshold for alert generation. The severity filter analyzes the current feature value (i.e., the potential anomaly) to determine whether the current feature value of the feature is a significant deviation. In some embodiments, the severity is determined by computing a difference between the expected feature value and the current feature value and comparing the difference to the expected range of feature values. A maximum severity can be computed over a time window by computing multiple severity metrics over a time interval associated with the potential anomaly and determining a maximum value. The maximum severity value can be compared with a threshold severity that can be customized according to the particular system design and acceptable deviation of feature values. For instance, a system critical feature may have a lower severity threshold while a non-critical feature may have a greater severity threshold. If the severity filter determines that the severity metric is greater than the threshold severity, the filtering operation 305 applies the duration filter at operation 308. If the severity filter determines that the severity metric is less than the threshold severity, the filtering operation 305 terminates, no alert is generated, and the flow returns to operation 302. In some embodiments, the severity thresholds may be set by a user input, using a statistical measure such as a multiple of standard deviation, or as an absolute difference between the current feature value and the upper/lower boundary of the expected range.

At operation 308, the adaptive feature health monitoring system applies a duration filter to determine whether the potential anomaly condition satisfies a duration threshold for alert generation. The duration filter analyzes the length of time a potential anomaly condition is present. In some embodiments, the duration filter computes a start time interval of the potential anomaly and an end time interval of the potential anomaly. The duration filter determines a duration threshold (e.g., a number of minutes, hours, days, etc.) that an anomaly condition can exist prior to an alert being generated. In other embodiments, the duration filter can be satisfied if a threshold number of anomaly conditions are present within a pre-determined time window (e.g., 5 potential anomalies within 3 days). In some cases, the threshold is satisfied when the number of anomaly conditions is greater than the threshold number. If the duration filter determines that the duration metric is greater than the threshold duration, the filtering operation 305 determines that an anomaly condition satisfies conditions for alert generation and the flow proceeds to operation 310. If the duration filter determines that the duration metric is less than the threshold duration, the filtering operation 305 terminates, no alert is generated, and the flow returns to operation 302. In some embodiments, the duration thresholds may be set by a user input or as a defined portion of the set of historical feature values (e.g., 10% duration of a 30 day set of historical feature values).

In some embodiments, the adaptive feature health monitoring system can apply complex filters such as a cumulative severity filter. A cumulative severity score is a combination of the severity and duration of operation 306 and operation 308. For example, the cumulative severity can be an aggregate of the severity over the duration of the anomaly. The cumulative severity can be computed by performing an integration of the severity over the duration of the anomaly for a continuous set of feature values or a summation for feature values that are discrete using time stamps. The cumulative severity can be expected value based or confidence based. In some embodiments, the cumulative severity is computed and compared to a threshold cumulative severity. In other embodiments, the classification model is trained to predict model-level anomaly probability based on individual feature-level anomaly properties (e.g., severity, duration, concurrency, etc.), then adaptive feature health monitoring system using the model-level anomaly probability to determine whether an alert should be generated.

At operation 310, the adaptive feature health monitoring system generates an alert for the potential anomaly. The adaptive feature health monitoring system generates the alert to include a feature name, current feature value, severity metric, duration metric, time stamps, or other information associated with the potential anomaly.

In some embodiments, when the adaptive feature health monitoring system determines that the feature is in an anomaly condition, the feature is removed from use so that it is no longer input to machine learning models. In other embodiments, such as monitoring features that represent physical attributes of a device, when the adaptive feature health monitoring system determines that the feature is in an anomaly condition, the configuration of the device is adjusted to return the device to a normal state after the anomaly condition.

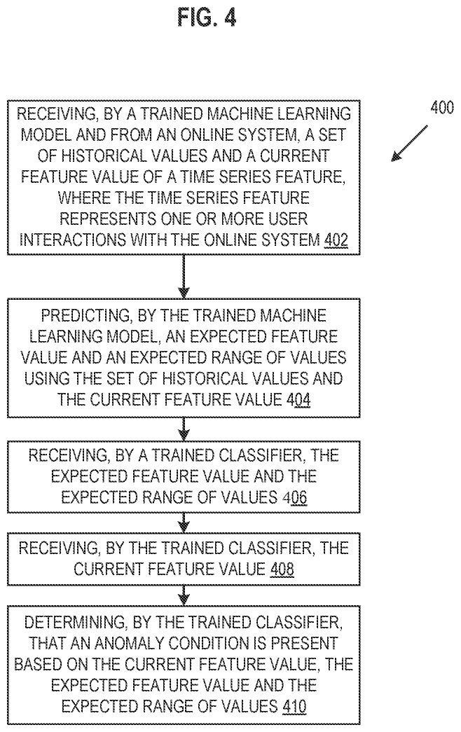

FIG. 4 is a flow diagram of an example method 400 of detecting anomalies by an anomaly detector in accordance with some embodiments of the present disclosure.

The method 400 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by portions of the adaptive feature health monitoring system 150 of FIG. 1.

Although shown in a particular sequence or order, unless otherwise specified, the order of the processes could be modified. Thus, the illustrated embodiments should be understood only as examples, and the illustrated processes could be performed in a different order, and some processes could be performed in parallel. Additionally, one or more processes could be omitted in various embodiments. Thus, not all processes are required in every embodiment. Other process flows are possible.

At operation 402, receiving, by a trained time series predictor and from an online system, a set of historical values and a current feature value of a time series feature, the time series feature represents one or more user interactions with the online system. For example, the time series predictor is a multilayer perceptron model that receives multiple time series features such as user clicks, message counts, content posts, document counts, activities by a user interacting with an online system, or other time series features. For each time series feature, the time series predictor receives a set of historical values and the current feature value.

At operation 404, the time series predictor predicts, an expected feature value and an expected range of values using the set of historical values and the current feature value. The time series predictor uses the set of historical values and the current feature value to provide the expected value and the range of expected values to an anomaly detector.

At operation 406 the anomaly detector receives the expected feature value, and the expected range of values. For example, the anomaly detector is configured to receive the expected feature value and the expected range of values from the output of the time series predictor. The anomaly detector is communicatively coupled to the time series predictor using inter-model communication using tensors, vectors, or other formats of outputs for the time series predictor.

At operation 408 the anomaly detector receives the current feature value. The anomaly detector receives the current feature value from the online system. In some examples, the current feature value (e.g., current day average, current day max/min, etc.) is the most recent feature value for user clicks, message counts, content posts, document counts, activities by a user interacting with an online system, or other time series features. In other embodiments, the current feature value can be a measured value from the online system in real-time or near real-time.

At operation 410, determining, by the anomaly detector, that an anomaly condition is present based on the current feature value, the expected feature value, and the expected range of values. The anomaly detector predicts an anomaly condition by comparing an upper boundary of the expected range and a lower boundary of the expected range to the current feature value. The anomaly detector computes a distance between the current feature value and the closest boundary of the expected range and determines whether the current feature value represents an anomaly condition.

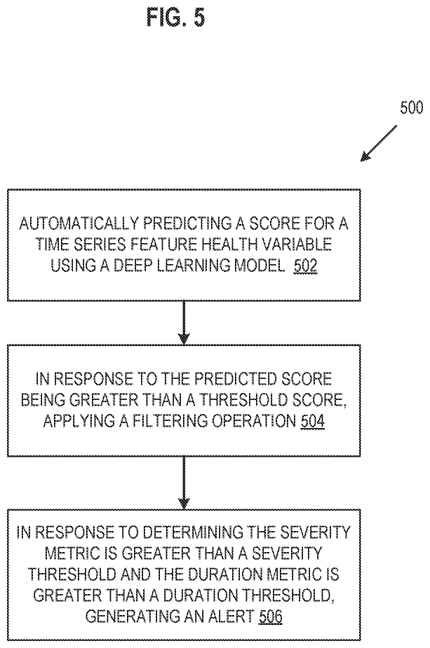

FIG. 5 is a flow diagram of an example method 500 of monitoring feature health and anomaly detection in accordance with some embodiments of the present disclosure.

The method 500 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by portions of the adaptive feature health monitoring system 150 of FIG. 1.

Although shown in a particular sequence or order, unless otherwise specified, the order of the processes could be modified. Thus, the illustrated embodiments should be understood only as examples, and the illustrated processes could be performed in a different order, and some processes could be performed in parallel. Additionally, one or more processes could be omitted in various embodiments. Thus, not all processes are required in every embodiment. Other process flows are possible.

At operation 502, the time series predictor automatically predicts a score for a time series feature health variable using a deep learning model. The time series predictor is trained using supervised learning to predict a score for a time series feature health variable. The time series predictor is a deep learning model that predicts the score after receiving a set of historical values and a current feature value of the time series feature health variable.

At operation 504, the adaptive feature health monitoring system applies a filtering operation in response to the predicted score being greater than a threshold score. The filtering operation analyzes all potential anomaly conditions as determined by the time series predictor and applies various filters to only generate alerts for anomaly conditions which satisfy each of the filters. In some embodiments, the filtering operation includes a duration filter and a severity filter, however, any number of features including a critical feature filter, concurrency filter, or level-shift filter can be applied. An example of the critical feature filter is a filter that is satisfied by any anomaly for any feature that is designated critical to the operation of the computing system 100 or the online platform. An example of the concurrency filter is a filter that is satisfied by a threshold number of features that all have anomaly conditions within a common time interval (e.g., 5 features have anomalies on a single day). An example of the level-shift filter is a filter that is satisfied by a series of time series values after a potential anomaly condition that cause a shift in the expected range to include the potential anomaly value (e.g., the expected values and range are adjusted to include the potential anomaly on an ongoing basis).

At operation 506, the adaptive feature health monitoring system generates an alert in response to the filtering operation determining that the severity metric and the duration metric exceed respective threshold values.

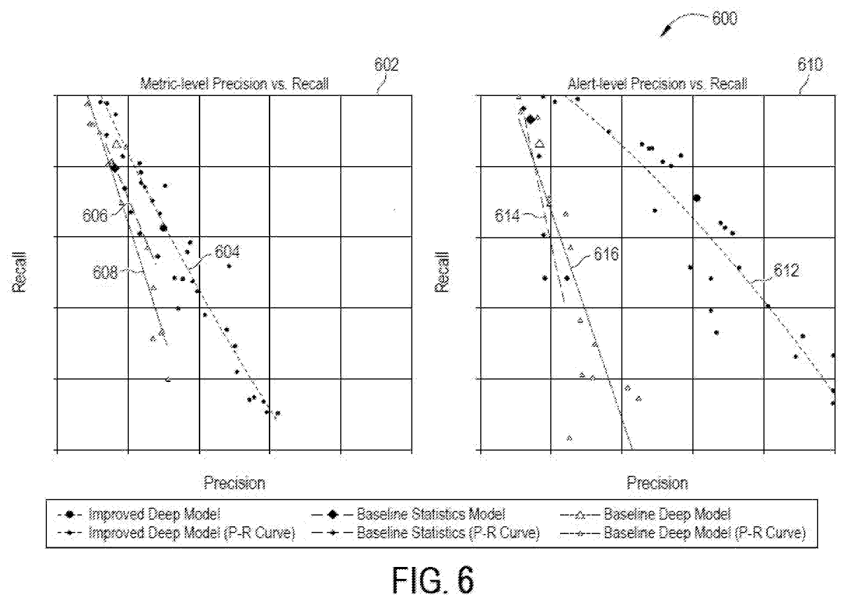

FIG. 6 is an example of a chart of machine learning results in accordance with some embodiments of the present disclosure. The chart 600 includes a first graph 602 that depicts a time series-level (feature level) precision-recall curve and a second graph 610 that depicts an alert-level (e.g., false alerts). The first graph 602 includes a first curve 604, a second curve 606, and a third curve 608. The first curve 604 depicts a precision-recall curve associated with embodiments of the present disclosure. The second curve 606 depicts a typical statistical model. The third curve 608 depicts a typical deep learning model. The second graph 610 includes a third curve 612, a fourth curve 614, and a fifth curve 616. The third curve 612 depicts an alert-level curve associated with embodiments of the present disclosure. The fourth curve 614 depicts a typical statistical model. The fifth curve 616 depicts a typical deep learning model. As depicted in the first graph 602, the first curve 604 illustrates a reduction in falsely detected alerts. As depicted in the second graph 610, the third curve 612 illustrates another reduction in falsely detected alerts.

FIG. 7 illustrates an example machine of a computer system 700 within which a set of instructions, for causing the machine to perform any one or more of the methodologies discussed herein, could be executed. In some embodiments, the computer system 700 corresponds to a component of a networked computer system (e.g., the computing system 100 of FIG. 1) that includes, is coupled to, or utilizes a machine to execute an operating system to perform operations corresponding to the adaptive feature health monitoring system 150 of FIG. 1.

The machine could be connected (e.g., networked) to other machines in a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine could be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a memory 706 (e.g., flash memory, static random-access memory (SRAM), etc.), an input/output system 710, and a data storage system 740, which communicate with each other via a bus 730.

The main memory 704 is configured to store instructions 714 for performing the operations and steps discussed herein. Instructions 714 include portions of adaptive feature health monitoring system 150 when those portions of adaptive feature health monitoring system 150 are stored in main memory 704. Thus, adaptive feature health monitoring system 150 is shown in dashed lines as part of instructions 714 to illustrate those portions of adaptive feature health monitoring system 150 could be stored in main memory 704. However, it is not required that adaptive feature health monitoring system 150 be embodied entirely in instructions 714 at any given time and portions of adaptive feature health monitoring system 150 could be stored in other components of computer system 700.

Processing device 702 represents one or more general-purpose processing devices such as a microprocessor, a central processing unit, or the like. More particularly, the processing device could be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 could be one or more special-purpose processing devices such as an application specific integrated circuit (ASIC), a field programmable gate array (FPGA), a digital signal processor (DSP), network processor, or the like. The processing device 702 is configured to execute instructions 712 for performing the operations and steps discussed herein.

Instructions 712 include portions of adaptive feature health monitoring system 150 when those portions of adaptive feature health monitoring system 150 are being executed by processing device 702. Thus, similar to the description above, adaptive feature health monitoring system 150 is shown in dashed lines as part of instructions 712 to illustrate that, at times, portions of adaptive feature health monitoring system 150 are executed by processing device 702. For example, when at least some portion of adaptive feature health monitoring system 150 is embodied in instructions to cause processing device 702 to perform the method(s) described above, some of those instructions could be read into processing device 702 (e.g., into an internal cache or other memory) from main memory 704 and/or data storage system 740. However, it is not required that all of adaptive feature health monitoring system 150 be included in instructions 712 at the same time and portions of adaptive feature health monitoring system 150 are stored in one or more other components of computer system 700 at other times, e.g., when one or more portions of adaptive feature health monitoring system 150 are not being executed by processing device 702.

The computer system 700 further includes a network interface device 708 to communicate over the network 720. Network interface device 708 provides a two-way data communication coupling to a network. For example, network interface device 708 could be an integrated-services digital network (ISDN) card, cable modem, satellite modem, or a modem to provide a data communication connection to a corresponding type of telephone line. As another example, network interface device 708 could be a local area network (LAN) card to provide a data communication connection to a compatible LAN. Wireless links could also be implemented. In any such implementation network interface device 708 sends and receives electrical, electromagnetic, or optical signals that carry digital data streams representing various types of information.

The network link provides data communication through at least one network to other data devices. For example, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system 700.

Computer system 700 sends messages and receives data, including program code, through the network(s) and network interface device 708. In the Internet example, a server transmits a requested code for an application program through the network interface device 708. The received code could be executed by processing device 702 as it is received, and/or stored in data storage system 740, or other non-volatile storage for later execution.

The input/output system 710 includes an output device, such as a display, for example a liquid crystal display (LCD) or a touchscreen display, for displaying information to a computer user, or a speaker, a haptic device, or another form of output device. The input/output system 710 includes an input device, for example, alphanumeric keys and other keys configured for communicating information and command selections to processing device 702. An input device can, alternatively or in addition, include a cursor control, such as a mouse, a trackball, or cursor direction keys for communicating direction information and command selections to processing device 702 and for controlling cursor movement on a display. An input device can, alternatively or in addition, include a microphone, a sensor, or an array of sensors, for communicating sensed information to processing device 702. Sensed information includes voice commands, audio signals, geographic location information, and/or digital imagery, for example.

The data storage system 740 includes a machine-readable storage medium 742 (also known as a computer-readable medium) which is stored in one or more sets of instructions 744 or software embodying any one or more of the methodologies or functions described herein. The instructions 744 also resides, completely or at least partially, within the main memory 704 and/or within the processing device 702 during execution thereof by the computer system 700, the main memory 704 and the processing device 702 also constitutes machine-readable storage media.

In one embodiment, the instructions 744 include instructions to implement functionality corresponding to a solver-based media assignment application (e.g., adaptive feature health monitoring system 150 of FIG. 1). Adaptive feature health monitoring system 150 is shown in dashed lines as part of instructions 744 to illustrate that, similar to the description above, portions of adaptive feature health monitoring system 150 could be stored in data storage system 740 alternatively or in addition to being stored within other components of computer system 700.

Dashed lines are used in FIG. 7 to indicate that it is not required that adaptive feature health monitoring system 150 be embodied entirely in instructions 712, 714, and 744 at the same time. In one example, portions of adaptive feature health monitoring system 150 are embodied in instructions 744, which are read into main memory 704 as instructions 714, and portions of instructions 714 are read into processing device 702 as instructions 712 for execution. In another example, some portions of adaptive feature health monitoring system 150 are embodied in instructions 744 while other portions are embodied in instructions 714 and still other portions are embodied in instructions 712.

While the machine-readable storage medium 742 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Illustrative examples of the technologies disclosed herein are provided below. An embodiment of the technologies could include any of the examples or a combination of the described below.

In an example 1, a method includes monitoring machine learning model features; receiving from an online system, by a deep learning-based time series predictor, a set of historical values and a current feature value of a time series feature, where the time series feature represents one or more user measured values of the online system; predicting, by the deep learning-based time series predictor, an expected feature value and an expected range of values using the set of historical values and the current feature value; receiving, by an anomaly detector, the expected feature value, and the expected range of values; receiving, by the anomaly detector, the current feature value; determining, by the anomaly detector, that an anomaly condition is present based on the current feature value, the expected feature value and the expected range of values, the determining including computing a severity metric by comparing the expected feature value and the expected range of values to the current feature value; computing a duration metric by computing a start time interval and an end time interval of the anomaly condition; determining that the severity metric satisfies a severity threshold; determining that the duration metric satisfies a duration threshold; generating and an alert for the anomaly condition that includes the severity metric and the duration metric. An example 2 includes the subject matter of example 1, and further includes performing a point-wise normalization for each historical value in the set of historical values in response to receiving a set of historical values; and predicting, by the deep learning-based time series predictor, an expected feature value and an expected range of values using the point-wise normalization for each historical value and the current feature value. An example 3 includes the subject matter of example 1 or example 2, further including performing a point-wise inverse normalization for each historical value in the set of historical values in response to predicting, by the deep learning-based time series predictor, an expected feature value and an expected range of values. An example 4 includes the subject matter of any of examples 1-3, further including identifying a first time interval of the set of historical values and a second time interval of historical values; determining that the first time interval includes one or more historical values within a threshold time interval to a current time; and removing the one or more historical values within the threshold time interval. An example 5 includes the subject matter of any of examples 1-4, further including computing a seasonality metric of the set of historical values using a pattern of the set of historical values over a time series; and amplifying, by the deep learning-based time series predictor an input feature using the seasonality metric. An example 6 includes the subject matter of any of examples 1-5, further including computing a seasonality metric, the computing including identifying a quantile of the set of historical values compared to a different set of historical values, where the quantile indicates a regularity of range of historical values; and setting a boundary condition for the expected range of values using the quantile, where the boundary condition has a first range for a quantile that indicates the regularity of historical values is within a threshold regularity. An example 7 includes the subject matter of any of examples 1-6, further including computing a seasonality metric, the computing including identifying a quantile of the set of historical values compared to a different set of historical values, where the quantile indicates a regularity of range of historical values; and setting a boundary condition for the expected range of values using the quantile, where the boundary condition has a second range for a quantile that indicates the regularity of historical values exceeds a threshold regularity.

In an example 8, a method includes monitoring machine learning model features for an online system, including automatically predicting a score for a time series feature health variable using a deep learning model, where the deep learning model is trained using supervised learning, the automatically predicting a score for a time series feature health variable using a deep learning model including receiving a set of historical values and a current feature value of the time series feature health variable, the time series feature health variable representing one or more user interactions with the online system, and the predicting uses the set of historical values and the current feature value; and applying a filtering operation in response to the predicted score being greater than a threshold score, the filtering operation including computing a severity metric using the score; computing a duration metric by using the score and a time interval; determining that the severity metric is greater than a severity threshold; determining that the duration metric is greater than a duration threshold; and generating an alert in response to the severity metric satisfying a severity threshold and the duration metric satisfying a duration threshold.

An example 9 includes the subject matter of example 8 further including performing a point-wise normalization for each historical value in the set of historical values in response to receiving the set of historical values; and predicting an expected feature value and an expected range of values using the point-wise normalization for each historical value and the current feature value. An example 10 includes the subject matter of example 8 or example 9 further including the threshold score computed using a severity metric and a duration metric, the severity metric comprising a comparison of the expected feature value and the expected range of values to the current feature value, and the duration metric comprising a start time interval and an end time interval of the predicted score being greater than a threshold score. An example 11 includes the subject matter of any of examples 8-10, further including identifying a plurality of time intervals associated with values of the features; determining that a first time interval of the plurality of time intervals includes one or more historical values within a threshold time interval to a current time; and removing the features associated with a first time interval. An example 12 includes the subject matter of any of examples 8-11, the deep learning model including a seasonality adaptive layer, the seasonality adaptive layer comparing a set of historical values using a pattern of the set of historical values over a time series. An example 13 includes the subject matter of any of examples 8-12 further including amplifying a time series feature health variable using the seasonality adaptive layer. An example 14 includes the subject matter of any of examples 8-13 where the seasonality adaptive layer computes a boundary condition for the expected range of values by identifying, a quantile of the set of historical values compared to a different set of historical values, where the quantile indicates a regularity of range of historical values; and setting a boundary condition for the expected range of values using the quantile, where the boundary condition has a first range for a quantile that indicates the regularity of historical values is within a threshold regularity. An example 15 includes the subject matter of any of examples 8-14 where the seasonality adaptive layer computes a boundary condition for the expected range of values by identifying, a quantile of the set of historical values compared to a different set of historical values, where the quantile indicates a regularity of range of historical values; and setting a boundary condition for the expected range of values using the quantile, where the boundary condition where the boundary condition has a second range for a quantile that indicates the regularity of historical values exceeds a threshold regularity.

In an example 16, a method includes obtaining a set of training time series feature values and a set of training anomaly labels, where each training anomaly label corresponds to each training time series feature value; training a deep learning-based time series predictor using the set of training time series feature to generate an expected feature value and an expected range of feature values; training an anomaly detector using set of training time series feature values and the set of training anomaly labels to detect an anomaly condition using the expected feature value and an expected range of feature values.

An example 17 includes the subject matter of example 16 where the set of training time series feature values includes a training feature value and a training range of feature values, and where the set of training anomaly labels include an identification of an anomaly condition and a type associated with the anomaly condition. An example 18 includes the subject matter of example 16 or example 17 where the type includes one or more of a severity, duration, cumulative severity, or concurrency. An example 19 includes the subject matter of any of examples 16-18, where the feature health monitoring system includes a seasonality adaptive layer, and where the set of training time series feature values includes a training seasonality value. An example 20 includes the subject matter of any of examples 16-19 further including performing a normalization operation on the set of training time series feature values prior to training the feature health monitoring system.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus could be specially constructed for the intended purposes, or include a general-purpose computer selectively activated or reconfigured by a computer program stored in the computer. For example, a computer system or other data processing system, such as the adaptive feature health monitoring system 150 could carry out the computer-implemented processes in response to its processor executing a computer program (e.g., a sequence of instructions) contained in a memory or other non-transitory machine-readable storage medium. Such a computer program could be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems could be used with programs in accordance with the teachings herein, or it proves convenient to construct a more specialized apparatus to perform the method. The structure for a variety of these systems will appear as set forth in the description below. In addition, the present disclosure is not described with reference to any particular programming language. It will be appreciated that a variety of programming languages could be used to implement the teachings of the disclosure as described herein.

The present disclosure could be provided as a computer program product, or software, which includes a machine-readable medium having stored thereon instructions, which could be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications could be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for monitoring machine learning model features, the method comprising:
receiving from an online system, by a deep learning-based time series predictor, a set of historical values and a current feature value of a time series feature, wherein the time series feature represents one or more measured values of the online system;
predicting, by the deep learning-based time series predictor, an expected feature value and an expected range of values using the set of historical values and the current feature value;
receiving, by an anomaly detector, the expected feature value, and the expected range of values;
receiving, by the anomaly detector, the current feature value;
determining, by the anomaly detector, that an anomaly condition is present based on the current feature value, the expected feature value and the expected range of values, the determining comprising:
computing a severity metric by comparing the expected feature value and the expected range of values to the current feature value;
computing a duration metric by computing a start time interval and an end time interval of the anomaly condition;
determining that the severity metric satisfies a severity threshold; and
determining that the duration metric satisfies a duration threshold
generating an alert for the anomaly condition that includes the severity metric and the duration metric.

2. The method of claim 1, further comprising:
in response to receiving a set of historical values, performing a point-wise normalization for each historical value in the set of historical values; and
predicting, by the deep learning-based time series predictor, an expected feature value and an expected range of values using the point-wise normalization for each historical value and the current feature value.

3. The method of claim 2, further comprising:
in response to predicting, by the deep learning-based time series predictor, an expected feature value and an expected range of values, performing a point-wise inverse normalization for each historical value in the set of historical values.

4. The method of claim 1, further comprising:
identifying a first time interval of the set of historical values and a second time interval of historical values;
determining that the first time interval includes one or more historical values within a threshold time interval to a current time; and
removing the one or more historical values within the threshold time interval.

5. The method of claim 1, further comprising:
computing a seasonality metric of the set of historical values using a pattern of the set of historical values over a time series; and
amplifying, by the deep learning-based time series predictor an input feature using the seasonality metric.

6. The method of claim 1, further comprising:
computing a seasonality metric, the computing comprising:
identifying a quantile of the set of historical values compared to a different set of historical values, wherein the quantile indicates a regularity of range of historical values; and
setting a boundary condition for the expected range of values using the quantile,
wherein the boundary condition has a first range for a quantile that indicates the regularity of historical values is within a threshold regularity.

7. The method of claim 1, further comprising:
computing a seasonality metric, the computing comprising:
identifying a quantile of the set of historical values compared to a different set of historical values, wherein the quantile indicates a regularity of range of historical values; and
setting a boundary condition for the expected range of values using the quantile,
wherein the boundary condition has a second range for a quantile that indicates the regularity of historical values exceeds a threshold regularity.

8. A method for monitoring machine learning model features for an online system, comprising:
automatically predicting a score for a time series feature health variable using a deep learning model, wherein the deep learning model is trained using supervised learning, the automatically predicting a score for a time series feature health variable using a deep learning model comprising:
receiving a set of historical values and a current feature value of the time series feature health variable, the time series feature health variable representing one or more user interactions with the online system, and the predicting uses the set of historical values and the current feature value; and
in response to the predicted score being greater than a threshold score, applying a filtering operation, the filtering operation comprising:
computing a severity metric using the score;
computing a duration metric by using the score and a time interval;
determining that the severity metric is greater than a severity threshold;
determining that the duration metric is greater than a duration threshold; and
in response to the severity metric satisfying a severity threshold and the duration metric satisfying a duration threshold, generating an alert.

9. The method of claim 8 further comprising:
in response to receiving the set of historical values, performing a point-wise normalization for each historical value in the set of historical values; and
predicting an expected feature value and an expected range of values using the point-wise normalization for each historical value and the current feature value.

10. The method of claim 9, wherein the threshold score is computed using a severity metric and a duration metric, the severity metric comprising a comparison of the expected feature value and the expected range of values to the current feature value, and the duration metric comprising a start time interval and an end time interval of the predicted score being greater than a threshold score.

11. The method of claim 9 further comprising:
identifying a plurality of time intervals associated with values of the features;
determining that a first time interval of the plurality of time intervals includes one or more historical values within a threshold time interval to a current time; and
removing the features associated with a first time interval.

12. The method of claim 9, wherein the deep learning model comprises a seasonality adaptive layer, the seasonality adaptive layer comparing a set of historical values using a pattern of the set of historical values over a time series.

13. The method of claim 12, further comprising amplifying a time series feature health variable using the seasonality adaptive layer.

14. The method of claim 13, wherein the seasonality adaptive layer computes a boundary condition for the expected range of values by identifying, a quantile of the set of historical values compared to a different set of historical values, wherein the quantile indicates a regularity of range of historical values; and
setting a boundary condition for the expected range of values using the quantile, wherein the boundary condition has a first range for a quantile that indicates the regularity of historical values is within a threshold regularity.

15. The method of claim 13, wherein the seasonality adaptive layer computes a boundary condition for the expected range of values by identifying, a quantile of the set of historical values compared to a different set of historical values, wherein the quantile indicates a regularity of range of historical values; and
setting a boundary condition for the expected range of values using the quantile, wherein the boundary condition wherein the boundary condition has a second range for a quantile that indicates the regularity of historical values exceeds a threshold regularity.

16. A method of training a feature health monitoring system, comprising:
obtaining a set of training time series feature values and a set of training anomaly labels, wherein each training anomaly label corresponds to each training time series feature value;
training a deep learning-based time series predictor using the set of training time series feature to generate an expected feature value and an expected range of feature values;
training an anomaly detector using set of training time series feature values and the set of training anomaly labels to detect an anomaly condition using the expected feature value and an expected range of feature values.

17. The method of claim 16, wherein the set of training time series feature values includes a training feature value and a training range of feature values, and wherein the set of training anomaly labels include an identification of an anomaly condition and a type associated with the anomaly condition.

18. The method of claim 17, wherein the type includes one or more of a severity, duration, cumulative severity, or concurrency.

19. The method of claim 16, wherein the feature health monitoring system includes a seasonality adaptive layer, and wherein the set of training time series feature values includes a training seasonality value.

20. The method of claim 16, further comprising performing a normalization operation on the set of training time series feature values prior to training the feature health monitoring system.
